(19) United States
(12) Patent Application Publication
(10) Pub. No.: US 2025/0029773 A1
(43) Pub. Date: Jan. 23, 2025

(54) COIL ELECTRONIC COMPONENT

(71) Applicant: SAMSUNG ELECTRO-MECHANICS CO., LTD., Suwon-si (KR)

(72) Inventors: Tae Hyun KIM, Suwon-si (KR); Donghwan LEE, Suwon-si (KR); Dong Jin LEE, Suwon-si (KR); Daeki LIM, Suwon-si (KR); Boumseock KIM, Suwon-si (KR)

(73) Assignee: SAMSUNG ELECTRO-MECHANICS CO., LTD., Suwon-si (KR)

(21) Appl. No.: 18/588,361

(22) Filed: Feb. 27, 2024

(30) Foreign Application Priority Data
Jul. 18, 2023 (KR) 10-2023-0092975

(51) Int. Cl. H01F 27/28; H01F 5/04

(52) U.S. Cl. CPC H01F 27/2823; H01F 5/04

(57) ABSTRACT

A coil electronic component is provided that includes a first coil including at least one turn of a first conductive wire, a second coil including at least one turn of a second conductive wire, an intermediate layer disposed between the first coil and the second coil and having a first permeability, and a magnetic body surrounding the first coil, the second coil, and the intermediate layer, and having a second permeability different from the first magnetic permeability. A cross-sectional shape of the first conductive wire and a cross-sectional shape of the second conductive wire are different.

### CROSS-REFERENCE TO RELATED APPLICATION

This application claims priority to and the benefit of Korean Patent Application No. 10-2023-0092975 filed in the Korean Intellectual Property Office on Jul. 18, 2023, the entire contents of which are incorporated herein by reference.

### TECHNICAL FIELD

The present disclosure relates to a coil electronic component.

Recently, as the functions of mobile devices has diversified, power consumption has increased, and coil electronic components with low loss and high efficiency have been adopted around power management integrated circuits (PMICs) to increase battery usage time in mobile devices.

When the coil electronic component has a coupled inductor structure in which a primary coil and a secondary coil are vertically stacked, a difference in direct current (DC) resistance Rdc may occur if the lengths of the primary coil and the secondary coil are different. The difference in DC resistance Rdc causes a difference in voltage across the coil and a difference in magnetic flux density. As a result, a difference in inductance between the primary coil and the secondary coil also occurs. Therefore, a method for reducing the DC resistance difference between coils in a coupled inductor structure is required.

### SUMMARY

The present disclosure attempts to provide a coil electronic component capable of reducing a DC resistance difference between coils in a coupled inductor structure.

However, embodiments of the present disclosure are not limited to those mentioned above, and may be variously extended in the scope of the technical ideas included in the present disclosure.

A coil electronic component according to an embodiment may include a first coil including at least one turn of a first conductive wire, a second coil including at least one turn of a second conductive wire, an intermediate layer disposed between the first coil and the second coil and having a first permeability, and a magnetic body surrounding the first coil, the second coil, and the intermediate layer, and having a second permeability different from the first permeability. A cross-sectional shape of the first conductive wire and a cross-sectional shape of the second conductive wire may be different.

In addition, a length of the first conductive wire may be greater than a length of the second conductive wire.

In addition, an area of a cross-section of the first conductive wire may be greater than an area of a cross-section of the second conductive wire.

In addition, the difference between the length of the first conductive wire and the length of the second conductive wire may be an average of about 0.2 mm, and an area of the cross-section of the first conductive wire may be an average of about 122% or more and about 150% or less of an area of the cross-section of the second conductive wire.

In addition, the area of the cross-section of the first conductive wire may be an average of about 0.0075 mm² or more and about 0.024 mm² or less, and an area of a cross-section of the second conductive wire may be an average of about 0.005 mm² or more and about 0.0184 mm² or less.

In addition, the difference between the DC resistance of the first conductive wire and the DC resistance of the second conductive wire may be an average of about 0.125 mohm or more and about 0.651 mohm or less.

In addition, the difference between the length of the first conductive wire and the length of the second conductive wire may be an average of 0.5 mm, and an area of a cross-section of the first conductive wire may be an average of about 172% or more and about 180% or less of the area of a cross-section of the second conductive wire.

In addition, the area of the cross-section of the first conductive wire may be an average of about 0.009 mm² or more and about 0.0322 mm² or less, and the area of the cross-section of the second conductive wire may be an average of 0.005 mm² or more and 0.0184 mm² or less.

In addition, the difference between the DC resistance of the first conductive wire and the DC resistance of the second conductive wire may be an average of about 0.212 mohm or more and about 0.432 mohm or less.

In addition, the cross-section of the first conductive wire may be circular or elliptical in shape, and the cross-section of the second conductive wire may be circular or elliptical in shape.

In addition, the cross-section of the first conductive wire may have a rectangular shape with rounded sides, and the cross-section of the second conductive wire may have a rectangular shape with rounded sides. The average length of a major axis passing the center of the cross-section of the first conductive wire may be greater than an average length of a major axis passing the center of the cross-section of the second conductive wire, and an average length of the minor axis intersecting the major axis at the center of the cross-section of the first conductive wire may be equal to an average length of the minor axis intersecting with the major axis at the center of the cross-section of the second conductive wire.

In addition, the cross-section of the first conductive wire may have a rectangular shape with rounded sides, and the cross-section of the second conductive wire may have a rectangular shape with rounded sides. An average length of the major axis passing the center of the first conductive wire may be equal to an average length of the major axis passing the center of the cross-section of the second conductive wire, and an average length of the minor axis intersecting the major axis at the center of the cross-section of the first conductive wire may be greater than the average length of the minor axis intersecting with the major axis at the center of the cross-section of the second conductive wire.

In addition, the intermediate layer may be in contact with the first coil and the second coil.

The intermediate layer may extend from a first region between a first core of the first coil and a second core of the second coil to a second region between the first coil and the second coil.

In addition, the intermediate layer may be in contact with an outer surface of the magnetic body.

In addition, a thickness of the intermediate layer in the first region may be the equal to a thickness of the intermediate layer in the second region.

In addition, the intermediate layer may extend from the first region to a part of the first core.

In addition, the intermediate layer may extend from the first region to a part of the second core.

The intermediate layer may extend from the first region to a part of the first core, and the intermediate layer may extend from the first region to a part of the second core.

The coil electronic component may further include a first external electrode disposed on the exterior of the magnetic body and connected to a first lead portion of the first coil, a second external electrode disposed on the exterior of the magnetic body and connected to the second lead portion of the first coil, a third external electrode disposed on the exterior of the magnetic body and connected to the first lead portion of the second coil, and a fourth external electrode disposed on the exterior of the magnetic body and connected to the second lead portion of the second coil.

According to the coil electronic component according to the embodiment, it is possible to reduce a DC resistance difference between coils by making the length of the primary coil and the cross-sectional shape of the secondary coil different in a coupled inductor structure.

### BRIEF DESCRIPTION OF THE DRAWINGS

FIG. 1 is a perspective view schematically illustrating a coil electronic component according to an embodiment.

FIG. 2 is a top plan view schematically illustrating the coil electronic component of FIG. 1.

FIG. 3 is a bottom perspective view schematically illustrating the coil electronic component of FIG. 1.

FIG. 4 is a schematic cross-sectional view taken along IV-IV′ line of FIG. 1.

FIG. 5 is a perspective view schematically illustrating a coil electronic component according to another embodiment.

FIG. 6 is a perspective view schematically illustrating a coil electronic component according to another embodiment.

FIG. 7 is a cross-sectional view schematically illustrating a coil electronic component according to another embodiment.

### DETAILED DESCRIPTION OF THE EMBODIMENTS

Hereinafter, the present disclosure will be described in detail hereinafter with reference to the accompanying drawings, in which embodiments of the present disclosure are shown. The drawings and description are to be regarded as illustrative in nature and not restrictive. Like reference numerals designate like elements throughout the specification. In the accompanying drawings, some constituent elements are exaggerated, omitted, or schematically illustrated, and the size of each constituent element does not entirely reflect the actual size.

The accompanying drawings are intended only to facilitate an understanding of the exemplary embodiments disclosed in this specification, and it is to be understood that the technical ideas disclosed herein are not limited by the accompanying drawings and include all modifications, equivalents, or substitutions that are within the range of the ideas and technology of the present disclosure.

Although terms of “first,” “second,” and the like are used to explain various constituent elements, the constituent elements are not limited to such terms. These terms are only used to distinguish one constituent element from another constituent element.

In addition, it will be understood that when an element such as a layer, film, region, or substrate is referred to as being “on” another element, it can be directly on the other element or intervening elements may also be present. In contrast, when an element is referred to as being “directly on” another element, there are no intervening elements present. Further, when an element is referred to as being “on” or “above” a reference element, it can be positioned above or below the reference element, and it is not necessarily referred to as being positioned “on” or “above” in a direction opposite to gravity.

Throughout the specification, the terms “comprise” or “have” are intended to specify the presence of stated features, integers, steps, operations, constituent elements, components or a combination thereof, but do not preclude the presence or addition of one or more other features, integers, steps, operations, constituent elements, components, and/or groups thereof. Therefore, unless explicitly described to the contrary, the word “comprise” and variations such as “comprises” or “comprising” will be understood to imply the inclusion of stated elements but not the exclusion of any other elements.

Further, throughout the specification, the phrase “in a plan view” or “on a plane” means viewing a target portion from the top, and the phrase “in a cross-sectional view” or “on a cross-section” means viewing a cross-section formed by vertically cutting a target portion from the side.

Throughout the specification, the term “connected” does not mean only that two or more constituent components are directly connected, but may also mean that two or more constituent components are indirectly connected through another constituent component, that two or more components are electrically connected as well as physically connected, or that two or more constituent components are referred to by different names but are united by location or function.

The term “about,” as used herein, means approximately. In general, the term “about” is used herein to modify a numerical value above and below the stated value by a variance of 10%. In one aspect, the term “about” means plus or minus 20% of the numerical value of the number with which it is being used.

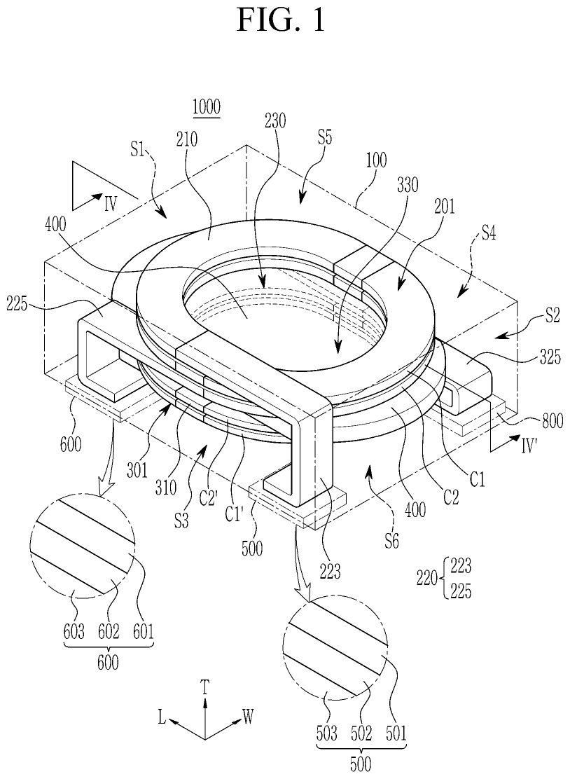

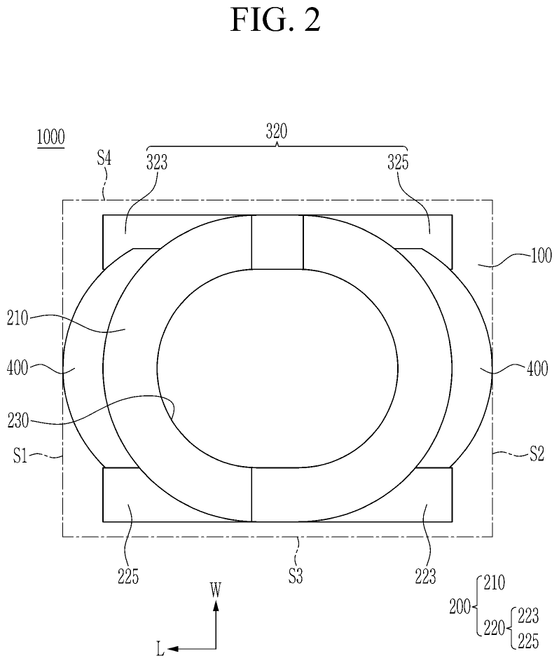

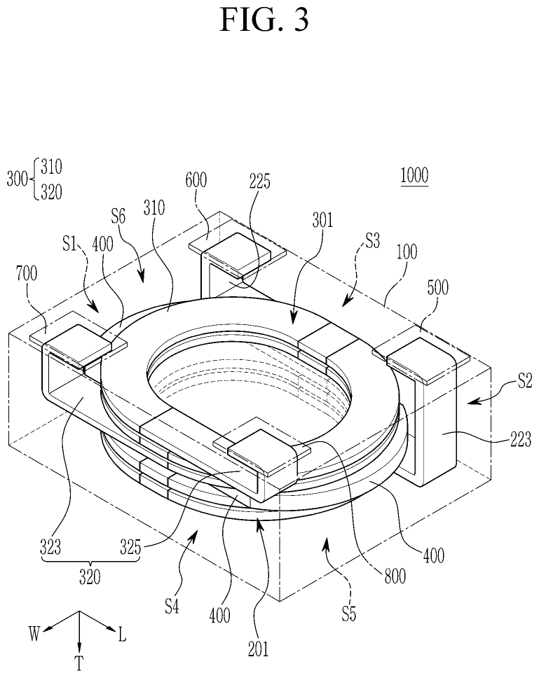

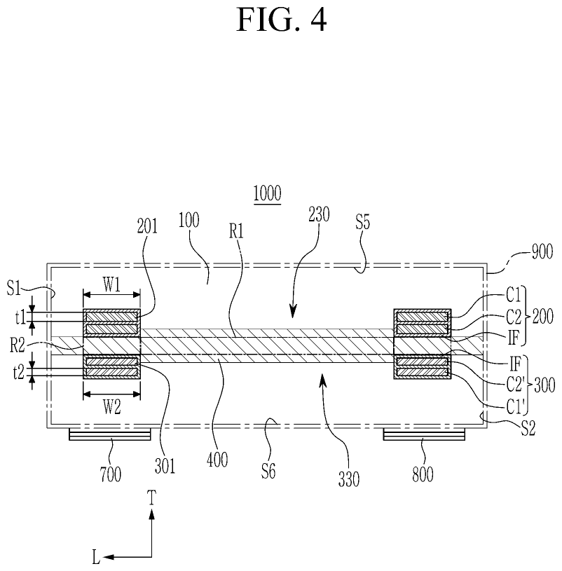

FIG. 1 is a perspective view schematically illustrating a coil electronic component according to some embodiments of the present disclosure. FIG. 2 is a top plan view schematically illustrating the coil electronic component of FIG. 1. FIG. 3 is a bottom perspective view schematically illustrating the coil electronic component of FIG. 1. FIG. 4 is a schematic cross-sectional view taken along IV-IV′ line of FIG. 1.

Referring to FIGS. 1, 2, 3, and 4, a coil electronic component 1000 according to some embodiments includes a magnetic body 100, a first coil 200, a second coil 300, an intermediate layer 400, a first external electrode 500, a second external electrode 600, a third external electrode 700, and a fourth external electrode 800.

The magnetic body 100 may be provided in a substantially rectangular parallelepiped shape, but the present embodiment is not limited thereto. Due to contraction of the magnetic powder or the like during sintering, the magnetic body 100 may have a substantially rectangular parallelepiped shape, although not a perfect rectangular parallelepiped shape. For example, the magnetic body 100 may have a substantially rectangular parallelepiped shape, but portions corresponding to corners or vertices may have a round shape.

In this embodiment, for convenience of description, the two surfaces facing in the length direction (L-axis direction) are defined as a first surface S1 and a second surface S2, respectively. The two surfaces facing in the width direction (W-axis direction) are defined as a third surface S3 and a fourth surface S4, respectively. The two surfaces facing in the thickness direction (T-axis direction) are defined as a fifth surface S5 and a sixth surface S6, respectively.

The length of the coil electronic component 1000 may mean, based on an optical microscope or scanning electron microscope (SEM) photograph of a length direction (L-axis direction)-thickness direction (T-axis direction) cross-section at a width direction (W-axis direction) central portion of the coil electronic component 1000, the maximum value among the lengths of a plurality of line segments each connecting two outermost boundary lines opposite in the length direction (L-axis direction) of the coil electronic component 1000, which is shown in the above-described cross-sectional photograph, and parallel to the length direction (L-axis direction). Alternatively, the length of the coil electronic component 1000 may mean the minimum value among the lengths of a plurality of line segments each connecting two outermost boundary lines opposite in the length direction (L-axis direction) of the coil electronic component 1000, which is shown in the above-described cross-sectional photograph, and parallel to the length direction (L-axis direction). Alternatively, the length of the coil electronic component 1000 may mean an arithmetic average value of the lengths of at least two line segments among a plurality of line segments each connecting two outermost boundary lines opposite in the length direction (L-axis direction) of the coil electronic component 1000, which is shown in the above-described cross-sectional photograph, and parallel to the length direction (L-axis direction).

The thickness of the coil electronic component 1000 may mean, based on an optical microscope or SEM photograph of the length direction (L-axis direction)-thickness direction (T-axis direction) cross-section at a width direction (W-axis direction) central portion of the coil electronic component 1000, the maximum value among the lengths of a plurality of line segments each connecting two outermost boundary lines opposite in the thickness direction (T-axis direction) of the coil electronic component 1000, which is shown in the above-described cross-sectional photograph, and parallel to the thickness direction (T-axis direction). Alternatively, the thickness of the coil electronic component 1000 may mean the minimum value among the lengths of a plurality of line segments each connecting two outermost boundary lines opposite in the thickness direction (T-axis direction) of the coil electronic component 1000, which is shown in the above-described cross-sectional photograph, and parallel to the thickness direction (T-axis direction). Alternatively, the thickness of the coil electronic component 1000 may mean an arithmetic average value of the lengths of at least two line segments among a plurality of line segments, each connecting two outermost boundary lines opposite in the thickness direction (T-axis direction) of the coil electronic component 1000, which is shown in the above-described cross-sectional photograph, and parallel to the thickness direction (T-axis direction).

The width of the coil electronic component 1000 may mean, based on an optical microscope or SEM photograph of the length direction (L-axis direction)-width direction (W-axis direction) cross-section at a thickness direction (T-axis direction) central portion of the coil electronic component 1000, the maximum value among the lengths of a plurality of line segments each connecting two outermost boundary lines opposite in the width direction (W-axis direction) of the coil electronic component 1000, which is shown in the above-described cross-sectional photograph, and parallel to the width direction (W-axis direction). Alternatively, the width of the coil electronic component 1000 may mean the minimum value among the lengths of a plurality of line segments each connecting two outermost boundary lines opposite in the width direction (W-axis direction) of the coil electronic component 1000, which is shown in the above-described cross-sectional photograph, and parallel to the width direction (W-axis direction). Alternatively, the width of the coil electronic component 1000 may mean an arithmetic average value of the lengths of at least two line segments among a plurality of line segments, each connecting two outermost boundary lines opposite in the width direction (W-axis direction) of the coil electronic component 1000, which is shown in the above-described cross-sectional photograph, and parallel to the width direction (W-axis direction).

Meanwhile, each of the length, width, and thickness of the coil electronic component 1000 may be measured using a micrometer measurement method. The micrometer measurement method may be measured by zeroing with a Gage R&R (Repeatability and Reproducibility) micrometer, inserting the coil electronic component 1000 according to the embodiment between the tips of the micrometer, and turning the measurement lever of the micrometer. Meanwhile, when measuring the length of the coil electronic component 1000 by the micrometer measurement method, the length of the coil electronic component 1000 may mean a value measured once, or mean an arithmetic average of values measured a plurality of times. This may be equally applied to measuring the width and thickness of the coil electronic component 1000.

The magnetic body 100 constitutes the exterior of the coil electronic component 1000, and is a space in which a magnetic path, a path through which a magnetic flux induced in the first coil 200 and a magnetic flux induced in the second coil 300 pass, when current is applied to the first coil 200 via the first external electrode 500 and the second external electrode 600, and current is applied to the second coil 300 via the third external electrode 700 and the fourth external electrode 800.

The magnetic body 100 surrounds and encapsulates the first coil 200, the second coil 300, and the intermediate layer 400, and includes a magnetic material. The magnetic material 100 includes magnetic particles, and an insulating material may be interposed between the magnetic particles.

The magnetic material may include a first magnetic metal powder, a second magnetic metal powder having a larger particle size than the first magnetic metal powder, and a third magnetic metal powder having a larger particle size than the second magnetic metal powder. An average particle diameter D₅₀ of the first magnetic metal powder may be about 0.1 μm or more and about 0.2 μm or less, the average particle diameter D₅₀ of the second magnetic metal powder may be about 1 μm or more and about 2 μm or less, and the average particle diameter D₅₀ of the third magnetic metal powder may be 25 μm or more and 30 μm or less.

The magnetic particles may include ferrite particles or metal magnetic particles exhibiting magnetic characteristics.

The ferrite particles may include, for example, at least one of a spinel-type ferrite, such as an Mg—Zn-based ferrite, an Mn—Zn-based ferrite, an Mn—Mg-based ferrite, an Cu—Zn-based ferrite, an Mg—Mn—Sr-based ferrite, a Ni—Zn-based ferrite, and the like, a hexagonal ferrite, such as a Ba—Zn-based ferrite, a Ba—Mg-based ferrite, a Ba—Ni-based ferrite, a Ba—Co-based ferrite, a Ba—Ni—Co-based ferrite, and the like, a garnet-type ferrite, such as Y-based ferrite, and the like, and an Li-based ferrite.

The metal magnetic particles may include two or more types of powders having different compositions, and may include one or more selected from the group consisting of iron (Fe), silicon (Si), chromium (Cr), cobalt (Co), molybdenum (Mo), aluminum (Al), niobium (Nb), copper (Cu), and nickel (Ni). For example, the metal magnetic particles may include at least one of a pure iron, an Fe—Si-based alloy, an Fe—Si—Al-based alloy, an Fe—Ni-based alloy, an Fe—Ni—Mo-based alloy, an Fe—Ni—Mo—Cu-based alloy, an Fe—Co-based alloy, an Fe—Ni—Co-based alloy, an Fe—Cr-based alloy, an Fe—Cr—Si-based alloy, an Fe—Si—Cu—Nb-based alloy, an Fe—Ni—Cr-based alloy, and an Fe—Cr—Al-based alloy. Here, different compositions of the metal magnetic particles may also mean different contents.

The metal magnetic particles may be amorphous or crystalline. For example, the metal magnetic particles may include an Fe—Si—B—Cr-based amorphous alloy, but the present embodiment is not limited thereto. The metal magnetic particles may have an average particle diameter of about 0.1 μm to about 30 μm, but is not limited thereto. In this specification, the average particle diameter may mean a particle size distribution represented as D₉₀ or D₅₀. Particle size distribution is well known to those of ordinary skill in the art as an indicator of what ratio of particles of what size (particle diameter) are contained within a population of particles to be measured.

D₅₀ refers to the average particle diameter and particle diameter corresponding to 50% of the cumulative volume of the particle size distribution.

The metal magnetic particles may include two or more types of different metal magnetic particles. Here, different types of metal magnetic particles may indicate that the metal magnetic particles are distinguished from each other based on at least one of an average particle diameter, a composition, component ratio, crystallinity, and a shape. The insulating material may include epoxy, polyimide, liquid-crystal polymer, and the like, alone or in combination, but is not limited thereto.

A method of forming the magnetic body 100 is not particularly limited. For example, the magnetic body 100 may be formed by disposing sheets made of a magnetic material on the upper and lower portions of the first coil 200 and the second coil 300, and then compressing and curing the sheets.

The first coil 200 and the second coil 300 are disposed inside the magnetic body 100, and exhibit characteristics of a coil electronic component. For example, when the coil electronic component 1000 of the present embodiment is utilized as a power inductor, if current is applied to the first coil 200 and the second coil 300, the first coil 200 and the second coil 300 may store energy as a magnetic field and maintain an output voltage, to perform a function of stabilizing power of an electronic device.

The first coil 200 and the second coil 300 may be magnetically coupled to each other to form a coupled inductor structure.

The first coil 200 may include at least one turn of a first conductive wire 201, and the second coil 300 may include at least one turn of a second conductive wire 301. For example, the first coil 200 and the second coil 300 may be formed by spirally winding a metal wire (e.g., copper (Cu) or silver (Ag)) with a surface coated with an insulating material.

That is, the first coil 200 and the second coil 300 may be wound coils. The first coil 200 and the second coil 300 are not limited to a single wire, and may be formed of twisted wires or two or more wires.

The first coil 200 and the second coil 300 may be circular coils, but are not limited thereto. For example, the first coil 200 and the second coil 300 may be various known coils such as rectangular coils.

Cross-sections of individual wires of the first coil 200 and the second coil 300 may have various well-known shapes such as a quadrangle, a circle, an ellipse, a triangle, and the like.

However, the length of the first conductive wire 201 of the first coil 200 may be greater than the length of the second conductive wire 301 of the second coil 300, and the cross-sectional shape of the first conductive wire 201 and the cross-sectional shape of the second conductive wire 301 may be different. Further, the area of the cross-section of the first conductive wire 201 may be larger than the area of the cross section of the second conductive wire 301.

Referring to FIG. 4, the cross-section of the first conductive wire 201 has a rectangular shape, and the cross-section of the second conductive wire 301 also has a rectangular shape. However, a thickness t1 of the first conductive wire 201 is greater than a thickness t2 of the second conductive wire 301. A width w1 of the first conductive wire 201 is equal to a width w2 of the second conductive wire 301. In FIG. 4, for convenience of description, the thickness and width of the first and second conductive wires are respectively shown except for the thickness of an insulating film IF, but since this is only an example, the thickness and width of the first and second conductive wires may include the thickness of the insulating film IF.

Here, the lengths of the first conductive wire 201 and the second conductive wire 301 are measured based on the center of the cross-section of each conductive wire. If the conductive wire has a bent shape, the length of the conductive wire is obtained by measuring the lengths of the straight parts separately and then adding the measured values. Meanwhile, the thickness and width of the first conductive wire 201 and the second conductive wire 301 are measured based on SEM photograph of a cross-section cut in the length direction (L-axis direction) and the thickness direction (T-axis direction) vertical to the width direction (W-axis direction) at the central portion of the width direction (W-axis direction) of the coil electronic component 1000 (hereinafter referred to as an “L-T cross-section”).

For example, the thickness of the first conductive wire 201 (or the second conductive wire 301) may be an arithmetic average value of the thicknesses of the first conductive wire 201 (or the second conductive wire 301) at three points spaced apart at equal intervals on the first conductive wire 201 (or the second conductive wire 301) at the outermost turn, in the L-T cross-section photograph.

Meanwhile, the width of the first conductive wire 201 (or the second conductive wire 301) may be an arithmetic average value of the widths of the first conductive wire 201 (or the second conductive wire 301) at three points spaced apart at equal intervals on the first conductive wire 201 (or the second conductive wire 301) at the outermost turn, in the L-T cross-section photograph.

Meanwhile, referring to FIG. 3, the first external electrode 500 and the second external electrode 600 are disposed on the sixth surface S6 of the magnetic body 100 and electrically connected to the first coil 200. In addition, the third external electrode 700 and the fourth external electrode 800 are disposed on the sixth surface S6 of the magnetic body 100 and electrically connected to the second coil 300. Because the first coil 200 is disposed above the second coil 300 (in the T-axis direction of FIG. 4), the distance between the first coil 200 and the sixth surface S6 of the magnetic body 100 is greater than the distance between the second coil 300 and the sixth surface S6 of the magnetic body 100. To connect the first coil 200 to the first external electrode 500 and the second external electrode 600, and to connect the second coil 300 to the third external electrode 700 and the fourth external electrode 800, the length of the first coil 200 should be longer than the length of the second coil 300. In particular, since the length difference between the first coil 200 and the second coil 300 increases as the number of turns of the first coil 200 and the second coil 300 increases, the difference between the DC resistance Rdc of the first conductive wire 201 and the DC resistance Rdc of the second conductive wire 301 may also increase.

Table 1 shows the expected value of difference in the DC resistance Rdc according to the length difference between the first and second conductive wires when the cross-sectional areas of the first conductive wire 201 of the first coil 200 and the second conductive wire 301 of the second coil 300 are the same.

TABLE 1

| Length difference | Cross-sectional area of conductive wire (mm²) | | | |
|---|---|---|---|---|
| between first | 0.23*0.08 = | 0.18*0.08 = | 0.18*0.05 = | 0.1*0.05 = |
| conductive wire | 0.0184 | 0.0144 | 0.009 | 0.005 |
| and second | Rdc | Rdc | Rdc | Rdc |
| conductive | difference | difference | difference | difference |
| wire (mm) | (mohm) | (mohm) | (mohm) | (mohm) |
| 0.1 | 0.93 | 1.19 | 1.91 | 3.44 |
| 0.2 | 1.87 | 2.39 | 3.82 | 6.88 |
| 0.3 | 2.80 | 3.58 | 5.73 | 10.32 |
| 0.4 | 3.74 | 4.78 | 7.64 | 13.76 |
| 0.5 | 4.67 | 5.97 | 9.56 | 17.20 |

Referring to Table 1, when the cross-sectional area of the conductive wire is 0.005 mm² and the length difference between the first conductive wire and the second conductive wire is 0.3 mm, the Rdc difference is expected to be 10.32 mohm. These Rdc differences are large and may need to be compensated for.

According to this embodiment, the cross-section of the first conductive wire 201 is rectangular in shape, and the cross-section of the second conductive wire 301 is also rectangular in shape. The thickness t1 of the first conductive wire 201 is greater than the thickness t2 of the second conductive wire 301, and the width w1 of the first conductive wire 201 is equal to the width w2 of the second conductive wire 301. Therefore, the area of the cross-section of the first conductive wire 201 is larger than the area of the cross-section of the second conductive wire 301. Therefore, compared to the case where the area of the cross-section of the first conductive wire 201 and the area of the cross-section of the second conductive wire 301 are the same, the magnitude of the DC resistance in the first conductive wire 201 may be smaller. Accordingly, a difference in the DC resistance between the first conductive wire 201 and the second conductive wire 301 may be reduced, and a difference in inductance between the first coil 200 and the second coil 300 may also be reduced.

Meanwhile, in another embodiment, the cross-section of the first conductive wire may have various known shapes such as circle, ellipse, triangle, and the like. The cross-section of the second conductive wire may also have various known shapes such as circle, ellipse, triangle, and the like. Even in such a case, the DC resistance difference between the first coil and the second coil may be reduced by adjusting the area of the cross-section of the first and second conductive wires, and thus the inductance difference may also be reduced.

For example, in some embodiments, each cross-section of the first conductive wire and the second conductive wire may have a rectangular shape with rounded sides. For example, in this case, the first and second conductive wire may have a major axis and a minor axis intersecting each other at the center of each cross-section. A major axis of any one cross-section of the first conductive wire (or the second conductive wire) may be a line segment connecting two tangents passing the outermost points of each of the two edges facing in a first direction in the corresponding cross-section. That is, the major axis may be the longest line segment connecting two edges facing in the first direction of a certain cross-section of the conductive wire. Meanwhile, the minor axis of any one cross-section of the first conductive wire (or the second conductive wire) may be a line segment connecting two tangents passing the outermost points of each of the two edges facing in a second direction intersecting the first direction in the corresponding cross-section. That is, the minor axis may be the longest line segment connecting two edges facing in the second direction of a certain cross-section of the conductive wire. When the radius of curvature of each side of the first and second conductive wire is the same, the area of the first and second conductive wires is proportional to the product of the length of the major axis and the length of the minor axis passing the center of each cross-section. For example, if the length of the major axis of the first conductive wire is greater than the length of the major axis of the second conductive wire, and the length of the minor axis of the first conductive wire is equal to the length of the minor axis of the second conductive wire, the area of the cross-section of the first conductive wire is greater than the area of the cross-section of the second conductive wire. Further, when the length of the major axis of the first conductive wire is equal to the length of the major axis of the second conductive wire, and the length of the minor axis of the first conductive wire is greater than the length of the minor axis of the second conductive wire, the area of the cross-section of the first conductive wire is greater than the area of the cross-section of the second conductive wire. Accordingly, it is possible to adjust the area of each cross-section of the first and second conductive wires by adjusting the lengths of the major axis and the minor axis of the first and second conductive wires, respectively. Here, the lengths of the major axis and the minor axis of the first conductive wire 201 (or the second conductive wire 301) are measured based on SEM photograph of a cross-section cut in the length direction (L-axis direction) and the thickness direction (T-axis direction) vertical to the width direction (W-axis direction) at the central portion of the width direction (W-axis direction) of the coil electronic component 1000 (hereinafter referred to as an “L-T cross-section”).

For example, the length of the major axis first conductive wire 201 (or the second conductive wire 301) may be an arithmetic average value of the length of the major axis the first conductive wire 201 (or the second conductive wire 301) at five points spaced apart at equal intervals on the first conductive wire 201 (or the second conductive wire 301) at the outermost turn, shown in the above-described L-T cross-section photograph. Meanwhile, the length of the minor axis of the first conductive wire 201 (or the second conductive wire 301) may be an arithmetic average value of the length of the minor axis of the first conductive wire 201 (or the second conductive wire 301) at five points spaced apart at equal intervals on the first conductive wire 201 (or the second conductive wire 301) at the outermost turn, shown in the above-described L-T cross-section photograph. Meanwhile, it is also possible to adjust the areas of each cross-section of the first conductive wire and the second conductive wire by accurately measuring the areas using known image analysis software.

The first coil 200 and the second coil 300 may have a plurality of turns and may be edgewise coils.

For example, the first coil 200 may have an outermost turn coil C1 and an innermost turn coil C2 sequentially from the fifth surface S5 to the sixth surface S6 of the coil electronic component 1000. Meanwhile, although not shown, at least one intermediate turn coil may be disposed between the outermost turn coil C1 and the innermost turn coil C2.

Similarly, the second coil 300 may have an outermost turn coil C1′ and an innermost turn coil C2′ sequentially from the sixth surface S6 to the fifth surface S5 of the coil electronic component 1000. Meanwhile, although not shown, at least one intermediate turn coil may be disposed between the outermost turn coil C1′ and the innermost turn coil C2′.

The insulating film IF may be provided along surfaces of each of the plurality of turns of the first coil 200 and the second coil 300. The insulating film IF is for protecting and insulating the plurality of turns of the first coil 200 and the second coil 300, and may include a known insulating material such as parylene. Any insulating material may be included in the insulating layer IF, and there is no particular limitation. For example, the insulating film IF may be a polyurethane resin, a polyester resin, an epoxy resin, or a polyamideimide resin. The insulating film IF may be formed by a method such as vapor deposition, but is not limited thereto.

Meanwhile, the shapes of the first coil 200 and the second coil 300 are not limited to those described above, and may have various known shapes. For example, the first coil 200 may have an outermost turn coil, one or more intermediate turn coils, and an innermost turn coil sequentially from the outer surface to the inner side of the magnetic body 100. Similarly, the second coil 300 may have an outermost turn coil, one or more intermediate turn coils, and an innermost turn coil sequentially from the outer surface to the inner side of the magnetic body 100.

The first coil 200 may include a winding portion 210 and a lead portion 220. The winding portion 210 is a part where a metal wire forms at least one turn. The lead portions 220 extend from both ends of the winding portion 210 and are exposed to the sixth surface S6 of the magnetic body 100, respectively. The lead portion 220 includes a first lead portion 223 and a second lead portion 225. The first lead portion 223 extends from one end of the winding portion 210 and is exposed to the sixth surface S6 of the magnetic body 100, and the second lead portion 225 extends from the other end of the winding portion 210 and is exposed to the sixth surface S6 of the magnetic body 100. The portions of the first lead portion 223 and the second lead portion 225 exposed to the sixth surface S6 of the magnetic body 100 may be spaced apart from each other in the length direction (L-axis direction), but are not limited thereto.

The second coil 300 may include a winding portion 310 and a lead portion 320.

The winding portion 310 is a part where a metal wire forms at least one turn.

The lead portions 320 extend from both ends of the winding portion 310 and are exposed to the sixth surface S6 of the magnetic body 100, respectively. The lead portion 320 includes a first lead portion 323 and a second lead portion 325. The first lead portion 323 extends from one end of the winding portion 310 and is exposed to the sixth surface S6 of the magnetic body 100, and the second lead portion 325 extends from the other end of the winding portion 310 and is exposed to the sixth surface S6 of the magnetic body 100. The portions of the first lead portion 323 and the second lead portion 325 exposed to the sixth surface S6 of the magnetic body 100 may be spaced apart from each other in the length direction (L-axis direction), but are not limited thereto.

The intermediate layer 400 is disposed between the first coil 200 and the second coil 300. For example, the intermediate layer 400 may be in contact with the first coil 200 and the second coil 300.

The intermediate layer 400 may have an elliptical shape or a race track shape when viewed in the thickness direction (T-axis direction), but is not limited thereto. The intermediate layer 400 may have a shape similar to that of the winding portion 210 of the first coil 200 or the winding portion 310 of the second coil 300.

The intermediate layer 400 may be disposed to extend from a first region R1 between a first core 230 of the first coil 200 and a second core 330 of the second coil 300 to a second region R2 between the first coil 200 and the second coil 300. The intermediate layer 400 may extend beyond the second region R2 to contact the outer surface of the magnetic body 100. For example, the intermediate layer 400 may contact the first surface S1 and the second surface S2 of the magnetic body 100.

The first core 230 may be a region in which a first hollow space of the first coil 200 is at least partially filled by the magnetic body 100. The second core 330 may be a region in which a second hollow space of the second coil 300 is at least partially filled by the magnetic body 100. That is, the magnetic body 100 filling the first hollow space of the first coil 200 may form the first core around which the first coil 200 is wound, and the magnetic body 100 filling the second hollow space of the second coil 300 may form the second core around which the second coil 300 is wound. The thickness of the intermediate layer 400 in the first region R1 may be the same as that of the intermediate layer 400 in the second region R2.

The thickness of the intermediate layer 400 is measured based on an optical microscope or a scanning electron microscope (SEM) picture in a cross-section of the coil electronic component 1000 in the length direction (L-axis direction)-thickness direction (T-axis direction) at the central portion in the width direction (W-axis direction). The thickness of the intermediate layer 400 in the first region R1 may be an arithmetic average value of the thickness of the intermediate layer 400 at ten points spaced apart at equal intervals on the intermediate layer 400 in the first region R1 of the coil electronic component 1000 shown in the above-described L-T cross-section photograph. The thickness of the intermediate layer 400 in the second region R2 may be an arithmetic average value of the thickness of the intermediate layer 400 at three points spaced apart at equal intervals on the intermediate layer 400 in the second region R2 of the coil electronic component 1000 shown in the above-described L-T cross-section photograph.

The thickness of the intermediate layer 400 in the first region R1 may be different from the thickness of the intermediate layer 400 in the second region R2. For example, the intermediate layer 400 may extend from the first region R1 to a part of the first core 230, or may extend from the first region R1 to a part of the second core 330. On the other hand, the intermediate layer 400 may extend from the first region R1 to a part of the first core 230 and a part of the second core 330.

When the intermediate layer 400 extends from the first region R1 to a part of the first core 230, the part of the first core 230 may be filled with the intermediate layer 400, and the remainder of the first core 230 may be filled with the magnetic body 100. Further, when the intermediate layer 400 extends from the first region R1 to a part of the second core 330, the part of the second core 330 may be filled with the intermediate layer 400, and the remainder of the second core 330 may be filled with the magnetic body 100. In this case, the magnetic body 100 and the intermediate layer 400, which fill the first hollow space of the first coil 200 may form the first core 230 around which the first coil 200 is wound, and the magnetic body 100 and the intermediate layer 400, which fill the second hollow space of the second coil 300 may form the second core 330 around which the second coil 300 is wound.

Meanwhile, the intermediate layer 400 may include a magnetic material and affect the magnetic coupling characteristics of the first coil 200 and the second coil 300. The intermediate layer 400 includes magnetic particles, and an insulating material may be interposed between the magnetic particles.

The magnetic material may include a first magnetic metal powder, a second magnetic metal powder having a larger particle size than the first magnetic metal powder, and a third magnetic metal powder having a larger particle size than the second magnetic metal powder. The average particle diameter D₅₀ of the first magnetic metal powder may be about 0.1 μm or more and about 0.2 μm or less, the average particle diameter D₅₀ of the second magnetic metal powder may be about 1 μm or more and about 2 μm or less, and the average particle diameter D₅₀ of the third magnetic metal powder may be about 25 μm or more and about 30 μm or less.

The magnetic particles may be ferrite particles or metal magnetic particles exhibiting magnetic characteristics.

The ferrite particles may include, for example, at least one of a spinel-type ferrite, such as an Mg—Zn-based ferrite, an Mn—Zn-based ferrite, an Mn—Mg-based ferrite, an Cu—Zn-based ferrite, an Mg—Mn—Sr-based ferrite, a Ni—Zn-based ferrite, and the like, a hexagonal ferrite, such as a Ba—Zn-based ferrite, a Ba—Mg-based ferrite, a Ba—Ni-based ferrite, a Ba—Co-based ferrite, a Ba—Ni—Co-based ferrite, and the like, a garnet-type ferrite, such as Y-based ferrite, and the like, and an Li-based ferrite.

The metal magnetic particles may include two or more types of powders having different compositions, and may include one or more selected from the group consisting of iron (Fe), silicon (Si), chromium (Cr), cobalt (Co), molybdenum (Mo), aluminum (Al), niobium (Nb), copper (Cu), and nickel (Ni). For example, the metal magnetic particles may be at least one of a pure iron, an Fe—Si-based alloy, an Fe—Si—Al-based alloy, an Fe—Ni-based alloy, an Fe—Ni—Mo-based alloy, an Fe—Ni—Mo—Cu-based alloy, an Fe—Co-based alloy, an Fe—Ni—Co-based alloy, an Fe—Cr-based alloy, an Fe—Cr—Si-based alloy, an Fe—Si—Cu—Nb-based alloy, an Fe—Ni—Cr-based alloy, and an Fe—Cr—Al-based alloy. Here, different compositions of the metal magnetic particles may also mean different contents.

The metal magnetic particles may be amorphous or crystalline. For example, the metal magnetic particles may include an Fe—Si—B—Cr-based amorphous alloy, but the present embodiment is not limited thereto. The metal magnetic particles may have an average particle diameter of about 0.1 μm to about 30 μm, but is not limited thereto. In this specification, the average particle diameter may mean a particle size distribution represented as D₉₀ or D₅₀. Particle size distribution is well known to those of ordinary skill in the art as an indicator of what ratio of particles of what size (particle diameter) are contained within a population of particles to be measured. D₅₀ (particle diameter corresponding to 50% of the cumulative volume of the particle size distribution) refers to the average particle diameter.

The metal magnetic particles may include two or more types of different metal magnetic particles. Here, different types of metal magnetic particles may indicate that the metal magnetic particles are distinguished from each other based on at least one of an average particle diameter, a composition, component ratio, crystallinity, and a shape.

The insulating material may include epoxy, polyimide, liquid-crystal polymer, and the like, alone or in combination, but is not limited thereto.

The intermediate layer 400 includes the above materials, but the permeability of the intermediate layer 400 may be smaller or larger than that of the magnetic body 100. Furthermore, the permeability of the magnetic material 100 and the intermediate layer 400 may be appropriately set to adjust the coefficient of coupling K between the first coil 200 and the second coil 300.

For example, a method of adjusting the permeability of the magnetic body 100 and the intermediate layer 400 may be to make the volume fraction of the first magnetic particles included in the magnetic body 100 and the volume fraction of the second magnetic particles included in the intermediate layer 400 different. Here, the volume fraction of the magnetic particles means the ratio of the volume of the first magnetic particles to the volume of the magnetic body 100, or the volume of the second magnetic particles to the volume of the intermediate layer 400. In order to adjust the relative permeability of the magnetic body 100 and the intermediate layer 400 with the volume fractions of the first magnetic particles and the second magnetic particles, the first magnetic particles and the second magnetic particles may be implemented as the same material, for example, a metal alloy of the same composition. Meanwhile, as a method of adjusting the permeability of the magnetic body 100 and the intermediate layer 400, the area fraction of the first magnetic particles included in the magnetic body 100 and the second magnetic particles included in the intermediate layer 400 may be made different from each other when checked in cross-sectional area. Here, the area fraction of the magnetic particles means the ratio of the cross-sectional area of the first magnetic particles to the cross-sectional area of the magnetic body 100, or the ratio of the cross-sectional area of the second magnetic particles to the cross-sectional area of the intermediate layer 400.

A case where the permeability of the intermediate layer 400 is greater than the permeability of the magnetic body 100 may be a case where the volume fraction of the second magnetic particles included in the intermediate layer 400 is greater than the volume fraction of the first magnetic particles included in the magnetic body 100. When the permeability of the intermediate layer 400 is greater than the permeability of the magnetic body 100, the coefficient of coupling between the first coil 200 and the second coil 300 may be relatively reduced. Here, the coefficient of coupling being relatively reduced means that the coefficient of coupling is reduced compared to the case where the permeability of the intermediate layer 400 and the permeability of the magnetic body 100 are the same. When the permeability of the intermediate layer 400 is relatively large, the amount of magnetic flux flowing through the intermediate layer 400 is relatively large, and the mutual inductance due to the magnetic flux shared by the first coil 200 and the second coil 300 becomes smaller. Here, the magnetic flux flowing through the intermediate layer 400 may be understood as flowing through the intermediate layer 400 in a length direction (L-axis direction) in FIG. 4.

As a result, since the mutual inductance between the first coil 200 and the second coil 300 becomes smaller and the leakage inductance formed only in the first coil 200 or the second coil 300 becomes larger, so the coefficient of coupling between the first coil 200 and the second coil 300 becomes smaller.

On the contrary, a case where the permeability of the intermediate layer 400 is smaller than the permeability of the magnetic body 100 may be a case where the volume fraction of the second magnetic particles included in the intermediate layer 400 is smaller than the volume fraction of the first magnetic particles included in the magnetic body 100. When the permeability of the intermediate layer 400 is smaller than the permeability of the magnetic body 100, the coefficient of coupling between the first coil 200 and the second coil 300 may relatively increase. Here, the coefficient of coupling being relatively increased means that the coefficient of coupling increases compared to the case where the permeability of the intermediate layer 400 and the permeability of the magnetic body 100 are the same. When the permeability of the intermediate layer 400 is relatively small, the amount of magnetic flux flowing through the intermediate layer 400 is relatively small, and the mutual inductance due to the magnetic flux shared by the first coil 200 and the second coil 300 becomes larger. Here, the magnetic flux flowing through the intermediate layer 400 may be understood as flowing through the intermediate layer 400 in a length direction (L-axis direction) in FIG. 4.

As a result, since the mutual inductance between the first coil 200 and the second coil 300 becomes larger and the leakage inductance formed only in the first coil 200 or the second coil 300 becomes smaller, so the coefficient of coupling between the first coil 200 and the second coil 300 becomes larger.

The first external electrode 500 and the second external electrode 600 are disposed on the exterior the magnetic body 100, and electrically connected to the first coil 200.

The first external electrode 500 is disposed on the sixth surface S6 of the magnetic body 100. The first lead portion 223 of the first coil 200 is exposed to the sixth surface S6 of the magnetic body 100 and connected to the first external electrode 500. The second external electrode 600 is disposed on the sixth surface S6 of the magnetic body 100. The second lead portion 225 of the first coil 200 is exposed to the sixth surface S6 of the magnetic body 100 and connected to the second external electrode 600.

The first external electrode 500 and the second external electrode 600 may be include a conductive material, such as copper (Cu), aluminum (Al), silver (Ag), tin (Sn), gold (Au), nickel (Ni), lead (Pb), chromium (Cr), titanium (Ti), or an alloy thereof, but is not limited thereto.

The first external electrode 500 and the second external electrode 600 may include a plurality of metal layers formed by plating a conductive metal.

Referring to the circle on the right of FIG. 1, the first external electrode 500 may include a first metal layer 501, a second metal layer 502, and a third metal layer 503.

The first metal layer 501 may include copper (Cu) as a plating layer in contact with the first lead portion 223 of the first coil 200 and the outer surface of the magnetic body 100. The second metal layer 502 may include nickel (Ni) as a plating layer covering the first metal layer 501. The third metal layer 503 may include tin (Sn) as a plating layer covering the second metal layer 502. However, the present embodiment is not limited to such a three-layer structure, and a two-layer structure in which only one plating layer is added on the first metal layer 501 is also possible.

Referring to the circle on the left of FIG. 1, the second external electrode 600 may include a first metal layer 601, a second metal layer 602, and a third metal layer 603.

The first metal layer 601 may include copper (Cu) as a plating layer in contact with the second lead portion 225 of the first coil 200 and the outer surface of the magnetic body 100. The second metal layer 602 may include nickel (Ni) as a plating layer covering the first metal layer 601. The third metal layer 603 may include tin (Sn) as a plating layer covering the second metal layer 602. However, the present embodiment is not limited to such a three-layer structure, and a two-layer structure in which only one plating layer is added on the first metal layer 601 is also possible.

As described above, the first external electrode 500 and the second external electrode 600 may include nickel (Ni), copper (Cu), palladium (Pd), gold (Au), or an alloy thereof, and may include a plurality of plating layer. For example, the first external electrode 500 and the second external electrode 600 may include a combination of nickel (Ni) layer, copper (Cu) layer, nickel/copper (Ni/Cu) layer (a laminated metal layer of a nickel (Ni) layer and a copper (Cu) layer stacked in this order), palladium/nickel (Pd/Ni) layer (a laminated metal layer of a palladium (Pd) layer and a nickel (Ni) layer stacked in this order), palladium/nickel/copper (Pd/Ni/Cu) layer (a laminated metal layer of a palladium (Pd) layer, a nickel (Ni) layer and a copper (Cu) layer stacked in this order) and copper/nickel/copper (Cu/Ni/Cu) layer (a laminated metal layer of a copper (Cu) layer, a nickel (Ni) layer and a copper (Cu) layer stacked in this order).

In some embodiments, the outermost layer of the first external electrode 500 and the second external electrode 600 can also be composed of tin (Sn). The tin (Sn) plating layer has a relatively low melting point, which may improve the ease of mounting the first external electrode 500 and the second external electrode 600 on a substrate.

In general, a tin (Sn) plating layer may be bonded to an electrode pad on a substrate through a solder including a tin (Sn)-copper (Cu)-silver (Ag) alloy paste. That is, the tin (Sn) plating layer may be melted and bonded to the solder during a heat treatment (reflow) process.

The third external electrode 700 and the fourth external electrode 800 are disposed on the exterior the magnetic body 100 and electrically connected to the second coil 300.

The third external electrode 700 is disposed on the sixth surface S6 of the magnetic body 100, and the first lead portion 323 of the second coil 300 is exposed to the sixth surface S6 of the magnetic body 100 and connected to the third external electrode 700.

The fourth external electrode 800 is disposed on the sixth surface S6 of the magnetic body 100, and the second lead portion 325 of the second coil 300 is exposed to the sixth surface S6 of the magnetic body 100 and connected to the fourth external electrode 800.

Since the structures and components of the third external electrode 700 and the fourth external electrode 800 are the same as those of the first external electrode 500 and the second external electrode 600 described above, redundant descriptions thereof will be omitted.

Meanwhile, in the magnetic body 100 of the coil electronic component 1000 according to the embodiment, a region other than the region in which the first external electrode 500, the second external electrode 600, the third external electrode 700, and the fourth external electrode 800 are disposed may be disposed with an insulating layer 900. On the contrary, on the sixth surface S6 of the magnetic body 100, an insulating layer may be present in the region between the exposed portion of the first lead portion 223 of the first coil 200, the exposed portion of the second lead portion 225 of the first coil 200, the exposed portion of the first lead portion 323 of the second coil 300, and the exposed portion of the second lead portion 325 of the second coil 300.

In this case, the first external electrode 500, the second external electrode 600, the third external electrode 700, and the fourth external electrode 800 may cover a part of the insulating layer.

As described above, the insulating layer 900 is disposed on at least a part of the first surface S1, the second surface S2, the third surface S3, the fourth surface S4, the fifth surface S5, and the sixth surface S6 of the magnetic body 100, thereby preventing electrical shorts between other electronic components and the external electrodes 500, 600, 700, and 800.

The insulating layer 900 may be used as a resist when forming the external electrodes 500, 600, 700, and 800 by electrolytic plating, but is not limited thereto.

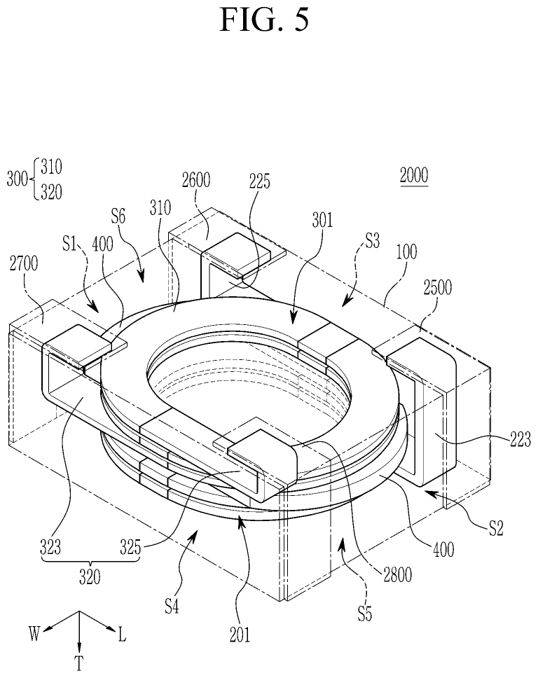

FIG. 5 is a perspective view schematically illustrating a coil electronic component according to another embodiment.

Referring to FIG. 5, a first external electrode 2500 of a coil electronic component 2000 according to another embodiment may be connected to the first lead portion 223 of the first coil 200 on the sixth surface S6 of the magnetic body 100, and may extend to the second surface S2 of the magnetic body 100. In addition, the second external electrode 2600 may be connected to the second lead portion 225 of the first coil 200 on the sixth surface S6 of the magnetic body 100, and may be extend to the first surface S1 of the magnetic body 100.

The third external electrode 2700 may be connected to the first lead portion 323 of the second coil 300 on the sixth surface S6 of the magnetic body 100, and may extend to the first surface S1 of the magnetic body 100. In addition, the fourth external electrode 2800 may be connected to the second lead portion 325 of the second coil 300 on the sixth surface S6 of the magnetic body 100, and may be extend to the second surface S2 of the magnetic body 100.

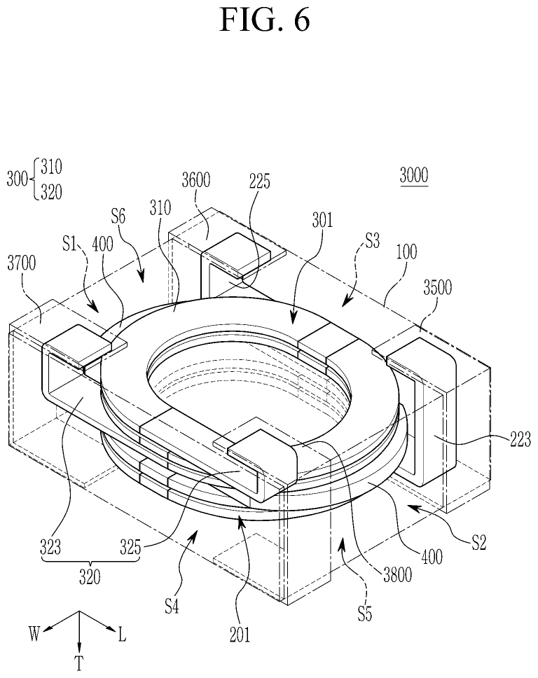

Other constituent elements except for the above are the same as those of the coil electronic component shown in FIG. 1, so a redundant description thereof will be omitted. FIG. 6 is a perspective view schematically illustrating a coil electronic component according to another embodiment.

Referring to FIG. 6, a first external electrode 3500 of a coil electronic component 3000 according to another embodiment may be connected to the first lead portion 223 of the first coil 200 on the sixth surface S6 of the magnetic body 100, and may extend to the second surface S2 and the fifth surface S5 of the magnetic body 100. In addition, a second external electrode 3600 may be connected to the second lead portion 225 of the first coil 200 on the sixth surface S6 of the magnetic body 100, and may be extend to the first surface S1 and the fifth surface S5 of the magnetic body 100.

The third external electrode 3700 may be connected to the first lead portion 323 of the second coil 300 on the sixth surface S6 of the magnetic body 100, and may be extend to the first surface S1 and the fifth surface S5 of the magnetic body 100. In addition, a fourth external electrode 3800 may be connected to the second lead portion 325 of the second coil 300 on the sixth surface S6 of the magnetic body 100, and may be extend to the second surface S2 and the fifth surface S5 of the magnetic body 100.

Other constituent elements except for the above are the same as those of the coil electronic component shown in FIG. 1, so a redundant description thereof will be omitted.

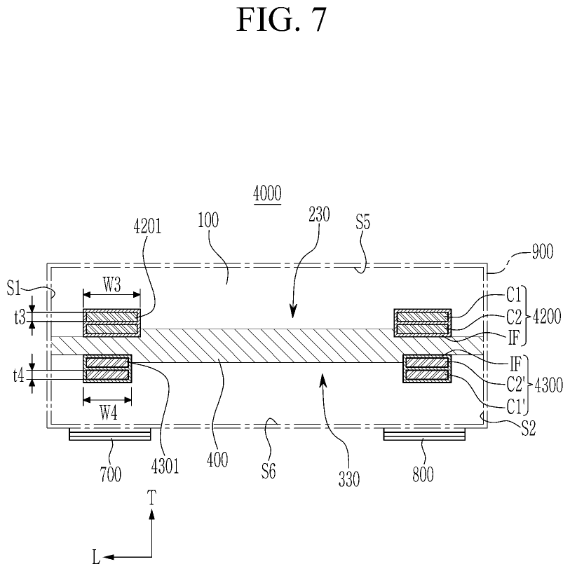

FIG. 7 is a cross-sectional view schematically illustrating a coil electronic component according to another embodiment.

Referring to FIG. 7, a coil electronic component 4000 according to another embodiment may include a magnetic body 100, a first coil 4200, a second coil 4300, and an intermediate layer 400.

The first coil 4200 may include at least one turn of a first conductive wire 4201, and the second coil 4300 may include at least one turn of the second conductive wire 4301. The length of the first conductive wire 4201 of the first coil 4200 may be greater than the length of the second conductive wire 4301 of the second coil 4300.

According to the embodiment, the cross-section of the first conductive wire 4201 is rectangular in shape, and the cross-section of the second conductive wire 4301 is also rectangular in shape. A width w3 of the first conductive wire 4201 is greater than a width w4 of the second conductive wire 4301, and a thickness t3 of the first conductive wire 4201 is equal to a thickness t4 of the second conductive wire 4301. Therefore, the area of the cross-section of the first conductive wire 4201 is larger than the area of the cross-section of the second conductive wire 4301. Compared to the case where the cross-sectional area of the first conductive wire 4201 and the cross-sectional area of the second conductive wire 4301 are the same, the DC resistance of the first conductive wire 4201 may be smaller. Accordingly, a difference in DC resistance between the first conductive wire 4201 and the second conductive wire 4301 may be reduced, and a difference in inductance between the first coil 4200 and the second coil 4300 may also be reduced.

The intermediate layer 400 may be disposed between the first coil 4200 and the second coil 4300, and may be in contact with the first surface S1 and the second surface S2 of the magnetic body 100.

Other constituent elements except for the above are the same as those of the coil electronic component shown in FIG. 1, so a redundant description thereof will be omitted. Hereinafter, specific examples of the present disclosure are provided. However, the examples described below are only intended to specifically illustrate or explain the present disclosure, and the range of the present disclosure should not be limited thereto.

### Manufacture Example: Manufacture of Coil Electronic Components

### Example 1

Manufacture a coil electronic component in which a cross-sectional area A1 of the first conductive wire of the first coil was 0.3 mm*0.08 mm=0.024 mm², a cross-sectional area A2 of the second conductive wire of the second coil is 0.23 mm*0.08 mm=0.0184 mm², and a value B1−B2 obtained by subtracting a length B2 of the second conductive wire from a length B1 of the first conductive wire was 0.2 mm.

### Example 2

the first conductive wire of the first coil was 0.23 mm*0.1 mm=0.023 mm², the cross-sectional area A2 of the second conductive wire of the second coil was 0.0184 mm², and from the length B1 of the first conductive wire was 0.2 mm.

### Comparative Example 1

Manufacture a coil electronic component in which the cross-sectional area A1 of the first conductive wire of the first coil was 0.3 mm*0.08 mm=0.024 mm², the cross-sectional area A2 of the second conductive wire of the second coil was 0.0184 mm², and the value B1−B2 obtained by subtracting the length B2 of the second conductive wire from the length B1 of the first conductive wire was 0.5 mm.

### Example 3

Manufacture a coil electronic component in which the cross-sectional area A1 of the first conductive wire of the first coil was 0.4 mm*0.08 mm=0.032 mm², the cross-sectional area A2 of the second conductive wire of the second coil was 0.0184 mm², and the value B1−B2 obtained by subtracting the length B2 of the second conductive wire from the length B1 of the first conductive wire was 0.5 mm.

### Comparative Example 2

Manufacture a coil electronic component in which the cross-sectional area A1 of the first conductive wire of the first coil was 0.23 mm*0.1 mm=0.023 mm², the cross-sectional area A2 of the second conductive wire of the second coil was 0.0184 mm², and the value B1−B2 obtained by subtracting the length B2 of the second conductive wire from the length B1 of the first conductive wire was 0.5 mm.

### Example 4

the first conductive wire of the first coil was 0.23 mm*0.14 mm=0.0322 mm², the cross-sectional area A2 of the second conductive wire of the second coil was 0.0184 mm², and the value B1−B2 obtained by subtracting the length B2 of the second conductive wire from the length B1 of the first conductive wire was 0.5 mm.

### Example 5

Manufacture a coil electronic component in which the cross-sectional area A1 of the first conductive wire of the first coil was 0.22 mm*0.08 mm=0.0176 mm², the cross-sectional area A2 of the second conductive wire of the second coil was 0.18 mm*0.08 mm=0.0144 mm², and the value B1−B2 obtained by subtracting the length B2 of the second conductive wire from the length B1 of the first conductive wire was 0.2 mm.

### Example 6

Manufacture a coil electronic component in which the cross-sectional area A1 of the first conductive wire of the first coil was 0.18 mm*0.1 mm=0.018 mm², the cross-sectional area A2 of the second conductive wire of the second coil was 0.0144 mm², and the value B1−B2 obtained by subtracting the length B2 of the second conductive wire from the length B1 of the first conductive wire was 0.2 mm.

### Comparative Example 3

Manufacture a coil electronic component in which the cross-sectional area A1 of the first conductive wire of the first coil was 0.22 mm*0.08 mm=0.0176 mm², the cross-sectional area A2 of the second conductive wire of the second coil was 0.0144 mm², and the value B1−B2 obtained by subtracting the length B2 of the second conductive wire from the length B1 of the first conductive wire was 0.5 mm.

### Comparative Example 4

the first conductive wire of the first coil was 0.25 mm*0.08 mm=0.02 mm², the cross-sectional area A2 of the second conductive wire of the second coil was 0.0144 mm², and from the length B1 of the first conductive wire was 0.5 mm.

### Example 7

Manufacture a coil electronic component in which the cross-sectional area A1 of the first conductive wire of the first coil was 0.31 mm*0.08 mm=0.0248 mm², the cross-sectional area A2 of the second conductive wire of the second coil was 0.0144 mm², and the value B1−B2 obtained by subtracting the length B2 of the second conductive wire from the length B1 of the first conductive wire was 0.5 mm.

### Comparative Example 5

Manufacture a coil electronic component in which the cross-sectional area A1 of the first conductive wire of the first coil was 0.18 mm*0.1 mm=0.018 mm², the cross-sectional area A2 of the second conductive wire of the second coil was 0.0144 mm², and the value B1−B2 obtained by subtracting the length B2 of the second conductive wire from the length B1 of the first conductive wire was 0.5 mm.

### Example 8

Manufacture a coil electronic component in which the cross-sectional area A1 of the first conductive wire of the first coil was 0.18 mm*0.14 mm=0.0252 mm², the cross-sectional area A2 of the second conductive wire of the second coil was 0.0144 mm², and the value B1−B2 obtained by subtracting the length B2 of the second conductive wire from the length B1 of the first conductive wire was 0.5 mm.

### Example 9

the first conductive wire of the first coil was 0.23 mm*0.05 mm=0.0115 mm², the cross-sectional area A2 of the second conductive wire of the second coil was 0.18 mm*0.05 mm=0.009 mm², and the value B1−B2 obtained by subtracting the length B2 of the second conductive wire from the length B1 of the first conductive wire was 0.2 mm.

### Example 10

Manufacture a coil electronic component in which the cross-sectional area A1 of the first conductive wire of the first coil was 0.18 mm*0.065 mm=0.0117 mm², the cross-sectional area A2 of the second conductive wire of the second coil was 0.009 mm², and the value B1−B2 obtained by subtracting the length B2 of the second conductive wire from the length B1 of the first conductive wire was 0.2 mm.

### Comparative Example 6

Manufacture a coil electronic component in which the cross-sectional area A1 of the first conductive wire of the first coil was 0.23 mm*0.05 mm=0.0115 mm², the cross-sectional area A2 of the second conductive wire of the second coil was 0.009 mm², and the value B1−B2 obtained by subtracting the length B2 of the second conductive wire from the length B1 of the first conductive wire was 0.5 mm.

### Comparative Example 7

Manufacture a coil electronic component in which the cross-sectional area A1 of the first conductive wire of the first coil was 0.25 mm*0.05 mm=0.0125 mm², the cross-sectional area A2 of the second conductive wire of the second coil was 0.009 mm², and the value B1−B2 obtained by subtracting the length B2 of the second conductive wire from the length B1 of the first conductive wire was 0.5 mm.

### Example 11

the first conductive wire of the first coil was 0.32 mm*0.05 mm=0.016 mm², the cross-sectional area A2 of the second conductive wire of the second coil was 0.009 mm², and from the length B1 of the first conductive wire was 0.5 mm.

### Comparative Example 8

Manufacture a coil electronic component in which the cross-sectional area A1 of the first conductive wire of the first coil was 0.18 mm*0.07 mm=0.0126 mm², the cross-sectional area A2 of the second conductive wire of the second coil was 0.009 mm², and the value B1−B2 obtained by subtracting the length B2 of the second conductive wire from the length B1 of the first conductive wire was 0.5 mm.

### Example 12

Manufacture a coil electronic component in which the cross-sectional area A1 of the first conductive wire of the first coil was 0.18 mm*0.09 mm=0.0162 mm², the cross-sectional area A2 of the second conductive wire of the second coil was 0.009 mm², and the value B1−B2 obtained by subtracting the length B2 of the second conductive wire from the length B1 of the first conductive wire was 0.5 mm.

### Example 13

Manufacture a coil electronic component in which the cross-sectional area A1 of the first conductive wire of the first coil was 0.15 mm*0.05 mm=0.0075 mm², the cross-sectional area A2 of the second conductive wire of the second coil was 0.10 mm*0.05 mm=0.005 mm², and the value B1−B2 obtained by subtracting the length B2 of the second conductive wire from the length B1 of the first conductive wire was 0.2 mm.

### Example 14

the first conductive wire of the first coil was 0.18 mm*0.065 mm=0.0117 mm², the cross-sectional area A2 of the second conductive wire of the second coil was 0.005 mm², and the value B1−B2 obtained by subtracting the length B2 of the second conductive wire from the length B1 of the first conductive wire was 0.2 mm.

### Comparative Example 9

Manufacture a coil electronic component in which the cross-sectional area A1 of the first conductive wire of the first coil was 0.13 mm*0.05 mm=0.0065 mm², the cross-sectional area A2 of the second conductive wire of the second coil was 0.005 mm², and the value B1−B2 obtained by subtracting the length B2 of the second conductive wire from the length B1 of the first conductive wire was 0.5 mm.

### Comparative Example 10

Manufacture a coil electronic component in which the cross-sectional area A1 of the first conductive wire of the first coil was 0.16 mm*0.05 mm=0.008 mm², the cross-sectional area A2 of the second conductive wire of the second coil was 0.005 mm², and the value B1−B2 obtained by subtracting the length B2 of the second conductive wire from the length B1 of the first conductive wire was 0.5 mm.

### Example 15

Manufacture a coil electronic component in which the cross-sectional area A1 of the first conductive wire of the first coil was 0.18 mm*0.05 mm=0.009 mm², the cross-sectional area A2 of the second conductive wire of the second coil was 0.005 mm², and the value B1−B2 obtained by subtracting the length B2 of the second conductive wire from the length B1 of the first conductive wire was 0.5 mm.

### Comparative Example 11

the first conductive wire of the first coil was 0.10 mm*0.07 mm=0.007 mm², the cross-sectional area A2 of the second conductive wire of the second coil was 0.005 mm², and from the length B1 of the first conductive wire was 0.5 mm.

### Example 16

Manufacture a coil electronic component in which the cross-sectional area A1 of the first conductive wire of the first coil was 0.10 mm*0.09 mm=0.009 mm², the cross-sectional area A2 of the second conductive wire of the second coil was 0.005 mm², and the value B1−B2 obtained by subtracting the length B2 of the second conductive wire from the length B1 of the first conductive wire was 0.5 mm.

### Experimental Example: Performance of Coil Electronic Components

After manufacturing 30 pieces of coil electronic components of Example 1−16 and Comparative Example 1-11, respectively, the cross-sectional area A1 and the length B1 of the first conductive wire of the first coil, the cross-sectional area A2 and the length B2 of the second conductive wire of the second coil, and Rdc difference (Rdc1−Rdc2) between the first and second coils were measured, and the results are summarized in Table 2.

TABLE 2

| | A1 | A2 | ((A1 − A2)/ | B1 − B2 | Rdc1 − Rdc2 |
|---|---|---|---|---|---|
| | mm² | mm² | A2)*100 (%) | (mm) | (mohm) |
| Example 1 | 0.024 | 0.0184 | 30 | 0.2 | 0.125 |
| Example 2 | 0.023 | 0.0184 | 25 | 0.2 | 0.374 |
| Comparative | 0.024 | 0.0184 | 30 | 0.5 | 2.770 |
| Example 1 | | | | | |
| Example 3 | 0.032 | 0.0184 | 74 | 0.5 | 0.303 |
| Comparative | 0.023 | 0.0184 | 25 | 0.5 | 2.617 |
| Example 2 | | | | | |
| Example 4 | 0.0322 | 0.0184 | 75 | 0.5 | 0.267 |
| Example 5 | 0.0176 | 0.0144 | 22 | 0.2 | 0.651 |
| Example 6 | 0.018 | 0.0144 | 25 | 0.2 | 0.477 |
| Comparative | 0.0176 | 0.0144 | 22 | 0.5 | 3.583 |
| Example 3 | | | | | |
| Comparative | 0.02 | 0.0144 | 39 | 0.5 | 2.293 |
| Example 4 | | | | | |
| Example 7 | 0.0248 | 0.0144 | 72 | 0.5 | 0.432 |
| Comparative | 0.018 | 0.0144 | 25 | 0.5 | 3.344 |
| Example 5 | | | | | |
| Example 8 | 0.0252 | 0.0144 | 75 | 0.5 | 0.341 |
| Example 9 | 0.0115 | 0.009 | 28 | 0.2 | 0.498 |
| Example 10 | 0.0117 | 0.009 | 30 | 0.2 | 0.294 |
| Comparative | 0.0115 | 0.009 | 28 | 0.5 | 4.986 |
| Example 6 | | | | | |
| Comparative | 0.0125 | 0.009 | 39 | 0.5 | 3.669 |
| Example 7 | | | | | |
| Example 11 | 0.016 | 0.009 | 78 | 0.5 | 0.358 |
| Comparative | 0.0126 | 0.009 | 40 | 0.5 | 3.549 |
| Example 8 | | | | | |
| Example 12 | 0.0162 | 0.009 | 80 | 0.5 | 0.212 |
| Example 13 | 0.0075 | 0.005 | 50 | 0.2 | 0.498 |
| Example 14 | 0.0117 | 0.005 | 30 | 0.2 | 0.294 |
| Comparative | 0.0065 | 0.005 | 30 | 0.5 | 8.467 |
| Example 9 | | | | | |
| Comparative | 0.008 | 0.005 | 60 | 0.5 | 3.010 |
| Example 10 | | | | | |
| Example 15 | 0.009 | 0.005 | 80 | 0.5 | 0.382 |
| Comparative | 0.007 | 0.005 | 40 | 0.5 | 6.388 |
| Example 11 | | | | | |
| Example 16 | 0.009 | 0.005 | 80 | 0.5 | 0.382 |

Referring to Table 2, in the coil electronic component manufactured according to Examples 1-16, the Rdc difference between the first coil and the second coil was less than 1 mohm. When the difference in length between the first coil and the second coil is relatively small, at 0.2 mm compared to 0.5 mm, as in Examples 1 and 2, it can be seen that even if the difference in the cross-sectional area of the first conductive wire to the cross-sectional area of the second conductive wire is not large, at 30% and 25%, the difference in Rdc is 0.125 mohm and 0.374 mohm, so the improvement in DC resistance is achieved. When the length difference between the first coil and the second coil is relatively large, at 0.5 mm compared to 0.2 mm, as in Example 3, it can be seen that the difference in the cross-sectional area of the first conductive wire to the cross-sectional area of the second conductive wire is also relatively large, at 74% so the effect of improving the DC resistance is observed.

On the contrary, in the coil electronic component manufactured according to Comparative Example 1-11, the Rdc difference between the first coil and the second coil exceeds 1 mohm. In the case of Comparative Examples 1-11, the length difference between the first coil and the second coil is 0.5 mm, which is relatively large compared to 0.2 mm, while the difference in the cross-sectional area of the first conductive wire to the cross-sectional area of the second conductive wire is not relatively large, such as 30% (Comparative Example 1), 25% (Comparative Example 2), and 22% (Comparative Example 3), so the effect of improving the DC resistance is not significant.

While this disclosure has been described in connection with what is presently considered to be practical embodiments, it is to be understood that the disclosure is not limited to the disclosed embodiments, but, on the contrary, is intended to cover various modifications and equivalent arrangements included within the spirit and scope of the appended claims.

### DESCRIPTION OF SYMBOLS

1000, 2000, 3000, 4000: Coil electronic components
100: Magnetic body
200, 4200: First coil
201, 4201: First conductive wire
210: Winding portion
220: Lead portion
223: First lead portion
225: Second lead portion
230: First core
300, 4300: Second coil
301, 4301: Second conductive wire
310: Winding portion
320: Lead portion
323: First lead portion
325: Second lead portion
330: Second core
400: Intermediate layer
500, 2500, 3500: First external electrode
600, 2600, 3600: Second external electrode
700, 2700, 3700: Third external electrode
800, 2800, 3800: Fourth external electrode
900: Insulating layer
IF: Insulating film
R1: First region
R2: Second region

What is claimed is:

1. A coil electronic component, comprising:
a first coil including at least one turn of a first conductive wire;
a second coil including at least one turn of a second conductive wire;
an intermediate layer disposed between the first coil and the second coil and having a first permeability; and
a magnetic body surrounding the first coil, the second coil and the intermediate layer, and having a second permeability different from the first permeability,
wherein a cross-sectional shape of the first conductive wire and a cross-sectional shape of the second conductive wire are different.

2. The coil electronic component of claim 1, wherein:
a length of the first conductive wire is greater than a length of the second conductive wire.

3. The coil electronic component of claim 2, wherein:
an area of a cross-section of the first conductive wire is larger than an area of a cross-section of the second conductive wire.

4. The coil electronic component of claim 3, wherein:
a difference between the length of the first conductive wire and the length of the second conductive wire is an average of 0.2 mm,
the area of a cross-section of the first conductive wire is an average of 122% or more and 150% or less of the area of a cross-section of the second conductive wire.

5. The coil electronic component of claim 4, wherein:
the area of the cross-section of the first conductive wire is an average of 0.0075 mm² or more and 0.024 mm² or less,
the area of a cross-section of the second conductive wire is an average of 0.005 mm² or more and 0.0184 mm² or less.

6. The coil electronic component of claim 4, wherein:
a difference between the DC resistance of the first conductive wire and the DC resistance of the second conductive wire is an average of 0.125 mohm or more and 0.651 mohm or less.

7. The coil electronic component of claim 3, wherein:
a difference between the length of the first conductive wire and the length of the second conductive wire is an average of 0.5 mm,
the area of a cross-section of the first conductive wire is an average of 172% or more and 180% or less of the area of a cross-section of the second conductive wire.

8. The coil electronic component of claim 7, wherein:
the area of the cross-section of the first conductive wire is an average of 0.009 mm² or more and 0.0322 mm² or less,
the area of the cross-section of the second conductive wire is an average of 0.005 mm² or more and 0.0184 mm² or less.

9. The coil electronic component of claim 7, wherein:
a difference between the DC resistance of the first conductive wire and the DC resistance of the second conductive wire is an average of 0.212 mohm or more and 0.432 mohm or less.

10. The coil electronic component of claim 1, wherein:
the cross-sectional shape of the first conductive wire is circular or elliptical in shape,
the cross-sectional shape of the second conductive wire is circular or elliptical in shape.

11. The coil electronic component of claim 1, wherein:
the cross-sectional shape of the first conductive wire is a rectangular shape with rounded sides, and the cross-sectional shape of the second conductive wire is a rectangular shape with rounded sides,
an average length of a major axis passing the center of the cross-section of the first conductive wire is greater than an average length of a major axis passing the center of the cross-section of the second conductive wire,
an average length of a minor axis intersecting the major axis at the center of the cross-section of the first conductive wire is equal to an average length of a minor axis intersecting with the major axis at the center of the cross-section of the second conductive wire.

12. The coil electronic component of claim 1, wherein:
the cross-section of the first and second conductive wires have a rectangular shape with rounded sides,
an average length of a major axis passing the center of the first conductive wire is equal to an average length of a major axis passing the center of the cross-section of the second conductive wire,
an average length of a minor axis intersecting with the major axis at the center of the cross-section of the first conductive wire is greater than the average length of a minor axis intersecting the major axis at the center of the cross-section of the second conductive wire.

13. The coil electronic component of claim 1, wherein:
the intermediate layer is in contact with the first coil and the second coil.

14. The coil electronic component of claim 13, wherein:
the intermediate layer extends from a first region between a first core of the first coil and a second core of the second coil to a second region between the first coil and the second coil.

15. The coil electronic component of claim 14, wherein:
the intermediate layer is in contact with an outer surface of the magnetic body.

16. The coil electronic component of claim 14, wherein:
a thickness of the intermediate layer in the first region is equal to a thickness of the intermediate layer in the second region.

17. The coil electronic component of claim 14, wherein:
the intermediate layer extends from the first region to a part of the first core.

18. The coil electronic component of claim 14, wherein:
the intermediate layer extends from the first region to a part of the second core.

19. The coil electronic component of claim 14, wherein:
the intermediate layer extends from the first region to a part of the first core, and
the intermediate layer extends from the first region to a part of the second core.

20. The coil electronic component of claim 1, further comprising:
a first external electrode disposed on an exterior of the magnetic body and connected to a first lead portion of the first coil;
a second external electrode disposed on the exterior of the magnetic body and connected to a second lead portion of the first coil;
a third external electrode disposed on the exterior of the magnetic body and connected to the first lead portion of the second coil; and
a fourth external electrode disposed on the exterior of the magnetic body and connected to the second lead portion of the second coil.
